(19) United States
(12) Patent Application Publication
(10) Pub. No.: US 2017/0205836 A1
(43) Pub. Date: Jul. 20, 2017

(54) GAS DILUTION SYSTEM

(71) Applicant: Peter Adam, München (DE)

(72) Inventor: Peter Adam, München (DE)

(21) Appl. No.: 15/407,280

(22) Filed: Jan. 17, 2017

(30) Foreign Application Priority Data
Jan. 19, 2016 (DE) DE 102016000518.1

(51) Int. Cl. G05D 11/035

(52) U.S. Cl. CPC G05D 11/035

(57) ABSTRACT

A gas dilution system with at least two gas flow control elements. Each of the at least two gas flow control elements features an integrated measuring orifice, designed as a top piece in the form of a valve and connected to a gas container. The gas dilution system extracts gas with a required flow rate via the at least two gas flow control elements from the respectively connected gas container, mixes the extracted gasses at a required dilution ratio into a diluted gas mixture and to makes the diluted gas mixture available at the outlet.

The invention relates to a gas dilution system and a method for gas dilution as well as the application of at least two gas flow control elements for a gas dilution system.

### STATE OF THE ART

In the wake of gas dilution, different gasses can be mixed and a diluted gas mixture can be created. The volume share of the individual gasses in this diluted gas mixture is adjusted to a desired dilution ratio during gas dilution. For example, such diluted gas mixture can be generated and applied for calibrating gas sensors and/or a gas analysis measurement device.

Respective gas dilution system designs are often very bulky and take up a lot of space. Often, such gas dilution systems feature many individual construction parts, e.g. a multitude of individual measuring orifices, valves and pressure regulators. Gas dilution systems are therefore frequently very expensive to operate and produce and require complicated handling.

It is desirable to produce an improved and simplified gas dilution system.

### DISCLOSURE OF THE INVENTION

According to the invention, one gas dilution system and one method for gas dilution as well as the utilization of at least two gas flow control elements for a gas dilution system are described herein.

The gas dilution system features at least to gas flow control elements. Each of these gas flow control elements respectively features an integrated measuring orifice, is designed as a top piece in the form of a valve and connected with a gas container.

The gas dilution system is implemented for respectively removing gas from the respectively connected gas container via the at least two gas flow control elements with a required flow rate and to mix the extracted gasses at a required ratio, here designated as dilution ratio, into a diluted gas mix and to make available the diluted gas mixture at one outlet.

The gas flow control elements can be expediently placed directly onto the respective gas container and/or be directly connected with it. Contrary to a traditional gas dilution system, an individual gas flow control element is intended for each gas container, with direct connection. The gas flow control elements can be designed in such manner as to be to be flexible connected with—and removable from—the respective gas container, e.g. via a screw or plug connection. Gas flow control elements and gas containers can in particular also be connected in a fixed and/or removable manner.

The integrated measuring orifices can be e.g. designed as calibrated, integrated flow regulators. One orifice diameter of the individual measuring orifices can be varied expediently. It is in particular possible to set a flow rate via the integrated measuring orifices, enabling the removal of gas from the respective gas container.

Thanks to the gas flow control elements, it is possible to easily extract from the gas container the desired amount of the respective gas necessary for preparing the diluted gas mixtures. The diluted gas mixture with the desired dilution ratio can in particular only he prepared by adjusting the gas flow rate via the gas flow control elements and/or measuring orifices.

Note that via the respective gas flow control elements, it is possible to expediently extract the individual gasses (e.g. nitrogen, synthetic air) or also a mixture of various individual gasses (e.g. a mixture of a special quantity of CO₂ in a specific quantity of nitrogen) as required.

In particular thanks to the application of gas flow control elements, the gas dilution system can be designed in a compact and space-saving manner and can be produced and operated economically, at minimum effort and without further complications. This compact design makes the gas dilution system also suitable for mobile application in particular. The gas dilution system can specifically be operated without electricity. All elements required for controlling and/or adjusting the desired dilution ratios are expediently integrated into the gas flow control element.

It is in particular possible to prepare a dilution ratio in the ppb range, corresponding specifically to a volume mixture ratio of 10⁻⁷% by volume. The diluted gas mixture can be prepared via the gas dilution system with a relative measurement uncertainty of, concretely, less than 1%. The dilution ratio can for example be altered with flow rates from 0.25 l/min to 8.00 l/min in steps of 1/33 in particular.

The gas dilution system in particular also allows preparing a diluted gas mixture with reactive gasses as components. Reactive gasses, such as H₂S, SO₂, NO, NH₃ can for example be used. Traditional gas dilution systems mostly do not, or only with great difficulty, allow preparing such gas mixtures since such reactive gasses only have limited stability inside high-pressure gas containers; especially across the ppb range and the low ppm range. There exists a specific danger that due to the adsorption effects, the reactive gasses react with the gas container's wall. The gas dilution system according to the invention, however, enables overcoming these difficulties. Furthermore, the invention makes it possible to produce prepared gas mixtures dynamically, whereas traditional means often merely enable a static preparation of diluted gas mixtures.

The gas dilution system can be connected to a gas consumer via an outlet. The diluted gas mixture can for example be used for calibrating gas sensors and/or a gas analysis measuring device. To this end, a respective gas sensor and/or a respective gas analysis measuring device can be connected via the output of the gas dilution system.

Preferably, the required dilution ratio of the diluted gas mixtures is adjustable via the integrated measuring orifices of the at least two gas flow control elements. All elements required for adjusting the desired dilution ratio are thus integrated into the gas flow control elements in particular. For adjusting the dilution ratio, no additional elements are in particular required.

It is especially preferred that the required dilution ratio can be adjusted via the orifice diameter of the integrated measuring orifices of the at least two gas flow control elements. The flow rate of the respective gas can expediently be adjusted by the respective gas flow control element via the respective orifice diameter. The desired dilution ratio can in particular be prepared by adjusting the flow rates of the individual gases and, expediently, via the individual orifice diameters.

Preferably, the at least two gas flow control elements furthermore respectively comprise one integrated gas pressure regulator. The flow rate of the respective gas and, thus, the dilution ratio in particular can be adjusted in particular via the integrated gas pressure regulator and the integrated measuring orifice. The gas flow control elements can in particular be designed as VIPR elements (“Valve with Integrated Pressure Regulator”) in this case.

Preferably, the integrated measuring orifices are respectively designed as an integrated measuring orifice for critical flows, so-called critical orifices. Via such a measuring orifice, a critical flow (or, alternatively, choked flow) can be generated. The flow and/or flow rate of such a critical flow is in particular independent of the measuring orifice's downstream pressure. It is only dependent of the temperature and the pressure and/or the density of the upstream measuring orifice. The flow in this case can be expediently adjusted and/or regulated via the integrated gas pressure regulator and via the expedient adjustment of the upstream measuring orifice pressure.

In this case, the gas dilution system can in particular be constructed according to Standard ISO 6145-6:2003 (“Gas analysis—Preparation of calibration gas mixtures using dynamic volumetric methods—Part 6: Critical orifices”) and the requirements of this standard can be met.

According to a preferred design, the gas flow control elements can be connected firmly with the respective gas container. Gas flow control element and gas container preferably form a joint structural entity in this case. Especially preferred is a gas flow control element constructed as a top piece to the gas container, in which a gas pressure regulator and a measuring orifice are integrated. Such structural entities can be connected with the other gas dilution system in an uncomplicated manner. Should one gas container be exchanged, e.g. because it is empty, the delivery of a new gas container will automatically contain a new measuring orifice and, in particular, a new gas pressure regulator. Such structural entities can in particular be refilled in an easy manner. Thanks to the integrated measuring orifice and the expediently integrated gas pressure regulator, no additional elements for refilling are in particular required.

It is in particular not necessary for purposes of gas dilution to use additional gas pressure regulators or measuring orifices; all required elements are already integrated into the gas container. There is therefore no danger that individual gas pressure regulators or measuring orifices might get lost or misplaced. In the event of a defective individual gas pressure regulator or measuring orifice, it is not necessary to shut down the entire gas dilution system and no expensive repair or exchange works are required. Instead, only the respective gas container will be replaced.

It is especially preferred for the gas flow control element and the gas container to be designed as pressure gas container with integrated bottle valve, integrated pressure reducer and as measuring orifice with integrated flow rate regulator, which the applicant distributes mainly under the name of ECOCYL®. The gas flow control element for such pressure gas container is expediently integrated completed in a protective cage of the pressure gas container. Such pressure gas containers constitute a consumer-ready system, are safe and easy to use and can be refilled easily. For extracting gas, the respective flask valve can be opened and it is possible to choose a desired flow rate from the required flow rates.

It is especially preferred that gas flow control elements and gas containers are designed with integrated pressure reducers, distributed by the applicant mainly under the name LIV. Such a gas bottle is a very easily and quickly usable mobile system for the provision with gasses. Thanks to the integrated pressure reducer, a respective gas bottle is immediately ready for use. Such a gas bottle in particular comprises an aluminum container and a respectively integrated pressure reducer.

Preferably, the gas dilution system furthermore features an excess flow regulator, preferably a needle valve and/or a back pressure regulator. Thanks to the excess flow regulator, diluted gas not required for a gas consumer connected to the outlet can be omitted. A diluted gas flow rate required by the gas consumer can in particular be maintained.

Preferably, the gas dilution system furthermore features a gas integration connected with the at least two gas flow control elements. Thanks to this gas integration, the gasses extracted from the individual gas containers are merged. The gas integration can for example feature a useful number of gas pipelines.

This gas merger is particularly preferred as a cross fitting of gas pipelines and/or as a gas pipeline cross. A first connection of the cross fitting is preferably connected with an initial number of at least two gas flow control elements, a second connection of the cross fitting is preferably connected with a second number of at least two gas flow control elements. It is therefore possible to extract respective quantities of a respective initial number of gasses and, via a second connection, to extract a respective quantity of a respective second number of gasses, and to mix them in a cross fitting. The diluted gas mixture is thus prepared in the cross fitting. Preferably, a third connection of the cross fitting is connected to the outlet at which the diluted gas mixture is made available. A fourth cross fitting connection preferably connects to the excess flow regulator.

The initial cross fitting connection is preferably connected exactly with a gas flow control element. This gas flow control element is expediently meant for a gas container of a compensation gas, such as nitrogen. Since the second connection of the cross fitting is preferably connected with the remaining gas flow control elements in this case, which are expediently meant for the calibration gas, respectively. A mixture of 5 ppm CO₂ in nitrogen can for example be intended as initial calibration gas and a mixture of 5 ppm CO in nitrogen as a second calibration gas.

In addition to the above gas dilution system, the invention concerns furthermore a method for gas dilution and an application of at least two gas flow control elements for a gas dilution system. Versions of this method according to the invention and of this application according to the invention analogously result from the above description of the gas dilution system according to the invention.

Additional advantages and designs of the invention result from the description of the enclosed drawing.

Naturally, the features described above and below are applicable not merely in the respectively required combination, but in other combinations or by themselves as well. This does not require going beyond the scope of the present invention.

The invention is represented schematically in the drawing via an execution example. It is extensively described below also in reference of the drawing.

### DESCRIPTION OF FIGURES

FIG. 1 schematically shows a gas dilution system according to the state-of-the-art.

FIG. 2 schematically shows a preferred designed of a gas dilution system according to the invention.

FIG. 3 schematically shows another preferred design of a gas dilution system according to the invention.

FIG. 4 schematically shows a chronology of a flow rate and a pressure, which can be part of a preferred design of a gas dilution system according to the invention.

### EMBODIMENTS OF THE INVENTION

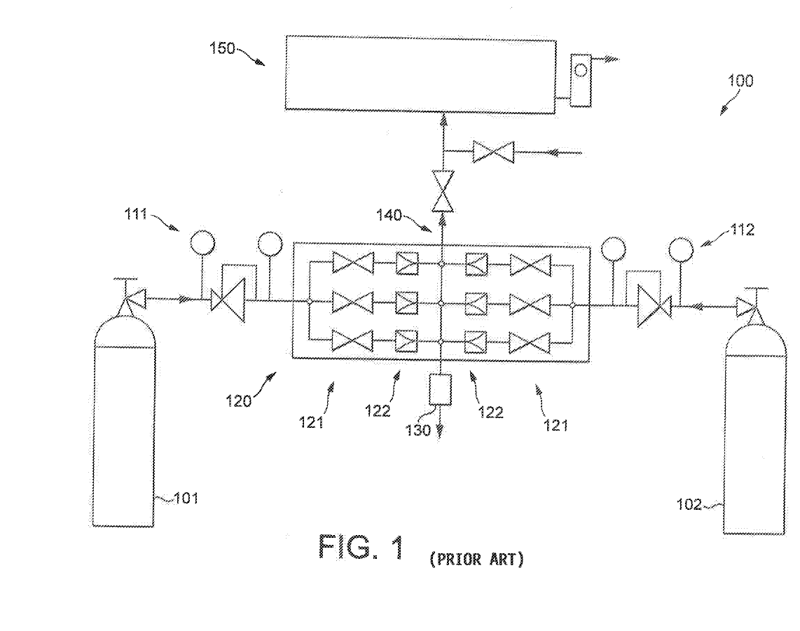

FIG. 1 schematically shows a gas dilution system according to the state-of-the-art; labeled 100.

This traditional gas dilution system 100 comprises an initial gas pressure container 101 and a second gas pressure container 102. The first gas pressure container 101 contains for example a compensation gas, e.g. nitrogen. The second pressure gas container 102 contains a calibration gas, e.g. a mixture of 5 ppm CO₂ in nitrogen.

For the initial and the second gas pressure container 101 and/or 102, a pressure regulator 111 and/or 112 is respectively available. A dilution unit 120 is intended hr mixing a certain quantity of compensation gas from the first container 101 with a certain quantity of calibration gas from the second container 102, resulting in a diluted gas mixture.

This dilution unit 120 comprises several valves 121 and measuring orifices 122. According to this example, six respective valves 121 and six measuring orifices 122 are intended for being able to generate the diluted gas mixture in a desired dilution ratio.

A regulator 130 is intended for maintaining a required flow rate of the diluted gas mixture and for releasing diluted gas mixture quantities that are not required.

The generated gas mixture is made available at an outlet 140. A gas analysis device 150 is for example connected to outlet 140. The generated diluted gas mixture can for example be used for calibrating the gas analysis-measuring device 150.

Such a traditional gas dilution system 100 has many disadvantages. The utilization of several valves 121 and measuring orifices 122 renders the gas dilution system 100 very bulky and requires a lot of space while operation and production are expensive. Furthermore, such a traditional gas dilution system 100 requires complicated handling due to the many structural parts.

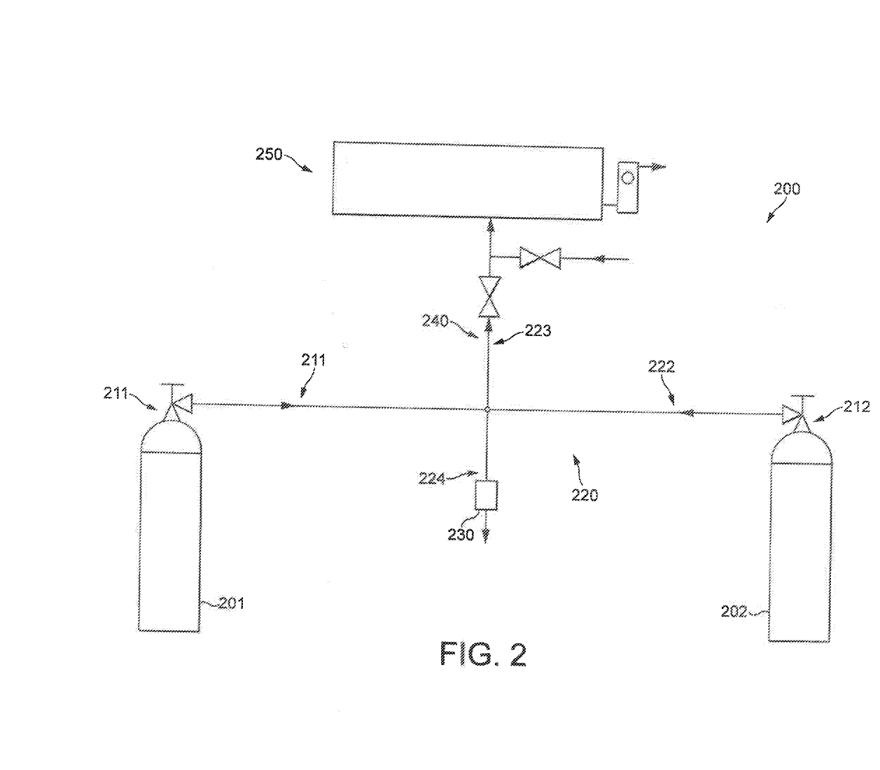

These disadvantages can be removed via a preferred design of a gas dilution system according to the invention, schematically shown in FIG. 2 under label 200.

The gas dilution system 200 in this example comprises an initial gas flow control element 211 and a second gas flow control element 212. Each of the gas flow control elements 211 and 212 respectively comprises an integrated gas pressure regulator and an integrated measuring orifice that can for example be created as an integrated flow rate regulator.

The gas flow control elements 211 and 212 are in particular each connected firmly with a gas container and/or pressure gas container 201 and 202.

An initial gas container 201 and the initial gas flow control element 211 and a second gas container 202 and the second gas flow control element 212 respectively form a joint structural entity. The gas flow control elements 211 and 212 are each expediently designed as top pieces in the manner of a valve.

An initial gas container 201 can for example contain a compensation gas such as nitrogen, a second gas container 202 might contain a calibration gas, e.g. a mixture of 4 ppm CO₂ in nitrogen.

The first gas pressure container 201 can for example contain a compensation gas, e.g. nitrogen. The second pressure gas container 202 contains a calibration gas, e.g. a mixture of 5 ppm CO₂ in nitrogen.

A gas integration 220 is connected with the gas flow control elements 211 and 212 and intended for merging the gasses extracted from gas containers 201 and 202, mixing them to become a diluted gas mixture.

Via the gas flow elements 211 and 212, gas can be extracted from the respective gas containers 201 and/or 202. By adjusting the diameters of the measuring orifices, the flow rate of the gasses extracted from the respective gas containers 201 and/or 202 can be adjusted. Adjusting these flow rates can serve to control the dilution ratio of the generated diluted gas mixture.

The integrated measuring orifices of the gas flow control elements 211 and 212 are in particular each designed as measuring orifices for critical flows in order to respectively create a critical flow via the gas flow control element 211 and/or 212. The flow rates of these critical flows are in particular respectively dependent on the temperature and the upstream pressure and/or the density of the respective measuring orifice. The can therefore expediently adjusted and controlled upstream in an easy and uncomplicated manner via the respective gas pressure regulator of the respective measuring orifice.

In this example, the gas integration 220 is designed as cross fitting. An initial connection 221 of cross fitting 220 is connected to an initial gas flow control element 211 and a second connection 222 of cross fitting 220 is connected with the second gas flow control element 212.

A third connection 223 of cross fitting 220 is connected to outlet 240 of the gas dilution system 200, at which the generated gas mixture is made available. Analogous to FIG. 1, it is for example possible to connect to outlet 250 a gas analysis-measuring device, which is calibrated via the generated diluted gas mixture.

A fourth connection 224 of cross fitting 220 is connected to an excess flow regulator 230. The excess flow regulator 230 in this example is designed as needle valve or back pressure regulator and is in particular intended for maintaining a required flow rate of diluted gas mixture and for releasing diluted gas mixture quantities that are not required.

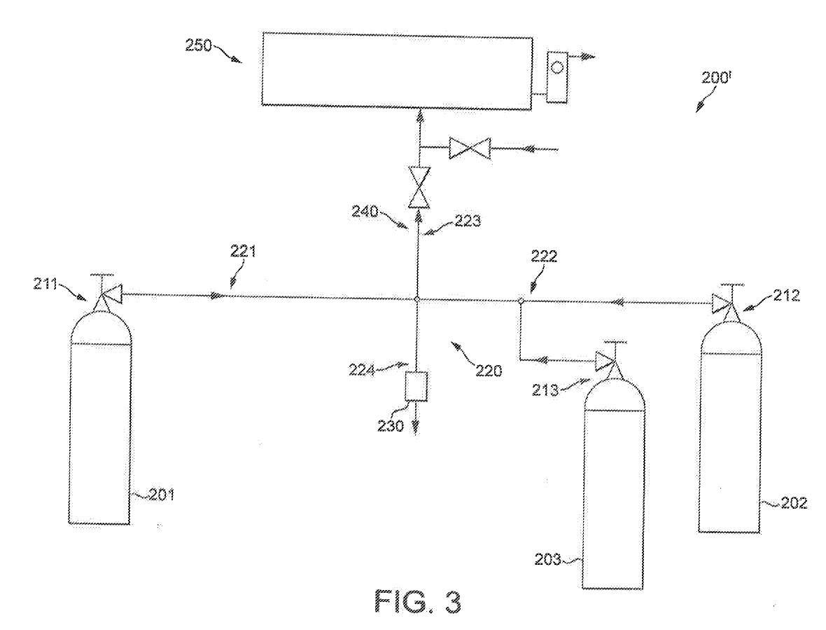

FIG. 3 schematically shows a further preferred design of a gas dilution system 200′ according to the invention. Identical referential labels in FIGS. 2 and 3 designate identical or structurally identical elements.

Contrary to the gas dilution system 200 according to FIG. 2, gas dilution system 200′ has a third gas flow control element 213 and a third gas container 203, which jointly also form a joint structural entity. Gas flow control element 213 is, analogously to gas flow control elements 211 and 212, designed as bottle valve with integrated gas pressure regulator and integrated measuring orifice. A mixture of 5 ppm CO in nitrogen is for example contained as additional calibration gas in a third gas container 203. The second connection 222 of cross fitting 220 is, in this example, connected, both, to the second gas flow control element 212 and the third gas flow control element 213.

In order to be able to best control the gasses extracted from the gas containers, the exactitude of the flow rate through the respective gas flow control element at a given pressure is in particular known. To this end, flow rate quantity curves against time and/or pressure against time of the respective gas flow control elements are in particular known.

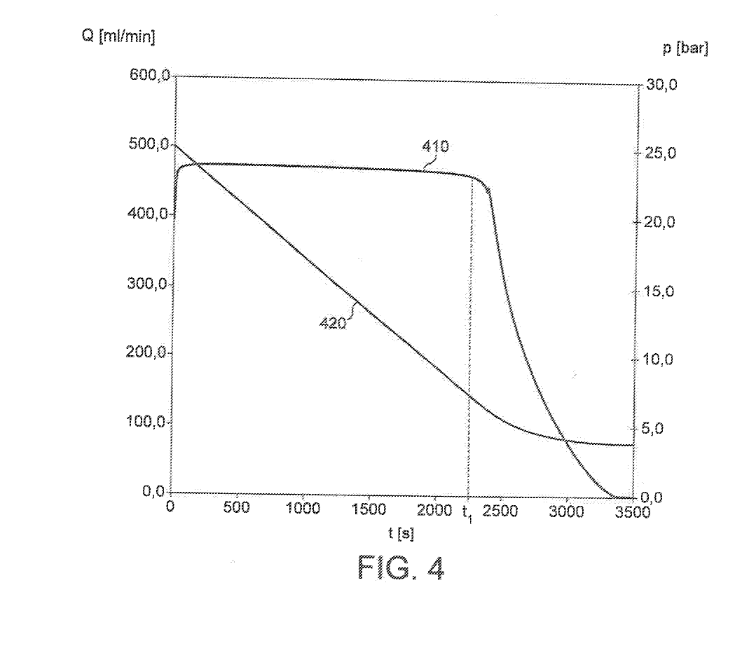

FIG. 4 schematically shows a respective diagram, whereas curve 410 describes the chronology of the flow and/or flow rate Q as unit [ml/min] and curve 420 describes the chronology of the unit pressure [bar]. Until moment t, flow rate Q can be kept stable and/or mainly stable.

The following provides an exemplary description how the concentration and/or the dilution ratio of outlet 240 of gas dilution system 200 acc. to the diluted gas mixture of FIG. 2 can be calculated.

Xₒᵤₜₗₑₜ designates the concentration and/or dilution ratio of the diluted gas mixture in the ppb range made available at outlet 240. xᵢₙₗₑₜ designates the concentration and/or dilution ratio of the calibration gas of the second gas container 202.

Qₚᵤᵣₑ designates the flow rate of the compensation gas throughout, which is extracted via the initial gas flow control element 211. Q_{cal} designates the flow rate of the calibration gas extracted via the second gas flow control element 212.

Concentration xₒᵤₜₗₑₜ can be in particular calculated as follows;

$${x}_{outlet} = {x}_{inlet} \frac{{Q}_{cal}}{{Q}_{cal} + {Q}_{pure}}$$

A measurement uncertainty and/or inaccuracy u (xₒᵤₜₗₑₜ) of this concentration dependent on the measurement uncertainty u (xᵢₙₗₑₜ) of the calibration gas concentration of measurement uncertainty u (Q_{cal}) of the flow rate of the calibration gas and of measurement uncertainty u (Qₚᵤᵣₑ) of the compensation gas can in particular be calculated as follows:

$${u ( {x}_{outlet} )}^{2} = {( \frac{{Q}_{cal}}{{Q}_{cal} + {Q}_{pure}} u ( {x}_{inlet} ) )}^{2} ++ {( ( \frac{{x}_{inlet}}{{Q}_{cal} + {Q}_{pure}} - \frac{{Q}_{cal} {x}_{inlet}}{{( {Q}_{cal} + {Q}_{pure} )}^{2}} ) u ( {Q}_{cal} ) )}^{2} + + {( \frac{{Q}_{cal} {x}_{inlet}}{{( {Q}_{cal} + {Q}_{pure} )}^{2}} u ( {Q}_{pure} ) )}^{2}$$

### LIST OF REFERENCE SIGNS

100 Gas dilution system acc. to the state-of-the-art
101 Initial pressure container
102 Second pressure container
111 Initial pressure regulator
112 Second pressure regulator
120 Dilution entity
121 Valves
122 Measuring orifices
130 Needle valve
140 Outlet
150 Gas analysis measuring device
200 Gas dilution system
200′ Gas dilution system
201 Initial pressure container
202 Second pressure container
203 Third pressure container
211 Initial pressure regulator, bottle valve
212 Second pressure regulator, bottle valve
213 Third pressure regulator, bottle valve
220 Gas integration, cross fitting
221 Initial connection of cross fitting
222 Second connection of cross fitting
223 Third connection of cross fitting
224 Third connection of cross fitting
230 Excess flow regulator (e.g. needle valve or back pressure regulator)
240 Outlet
250 Gas analysis measuring device
410 Chronology of flow rate Q
420 Chronology of pressure

1. Gas dilution system with at least two gas flow control elements, whereas each of the at least two gas flow control elements features each an integrated measuring orifice, designed as top piece in form of a valve and connected with a gas container, whereas the gas dilution system is designed for respectively removing gas with a required flow rate via the at least two gas flow control elements from the respectively connected gas container, to mix the extracted gasses into a diluted gas mixture at a required dilution ratio and to make available the diluted gas mixture at the outlet.

2. Gas dilution system according to claim 1, whereas the required dilution ratio of the diluted gas mixture is adjustable via the integrated measuring orifices of the at least two gas flow control elements.

3. Gas dilution system according to claim 2, whereas the required dilution ratio of the diluted gas mixture is adjustable via the orifice diameter of the integrated measuring orifices of the at least two gas flow control elements.

4. Gas dilution system according to claim 1, whereas the integrated measuring orifices are respectively designed as an integrated measuring orifice for critical flows.

5. Gas dilution system according to claim 1, whereas the at least two gas flow control elements each continue to comprise an integrated gas pressure regulator.

6. Gas dilution system according to claim 1, whereas the at least two gas flow control elements form a joint structural entity with the respectively connected gas container.

7. Gas dilution system according to claim 1, furthermore featuring an excess flow regulator, in particular a needle valve and/or a back pressure regulator.

8. Gas dilution system according to claim 1, furthermore feature a gas integration, especially as cross fitting of gas pipelines, which are connected with at least two gas flow control elements.

9. Gas dilution system according to claim 8, whereas an initial connection of cross fitting is connected with an initial number of the at least two gas flow control elements, a second connection of cross fitting is connected with a second number of the at least two gas flow control elements, a third connection of cross fitting is connected with outlet.

10. Gas dilution system according to claim 9, whereas a fourth connection of cross fitting is connected with excess flow regulator.

11. Gas dilution method, whereas at least two gas flow control elements are used, whereas each of the at least two gas flow control elements each feature an integrated measuring orifice, designed as top piece in the form of a valve and connected with a gas container, whereas via the at least two gas flow control elements gas is respectively extracted from the respectively connected gas container at a required flow rate, whereas the extracted gasses are mixed at a required dilution ratio into a diluted gas mixture.

12. Method according to claim 11, whereas the required dilution ratio of the diluted gas mixture is adjusted via the integrated measuring orifices of the at least two gas flow control elements.

13. Method according to claim 12, whereas the required dilution ratio of the diluted gas mixture is adjusted via the orifice diameter of the integrated measuring orifices of the at least two gas flow control elements.

14. Method according to claim 11, whereas one respective critical gas flow is generated via the integrated measuring orifices of the at least two gas flow control elements.

15. Application of at least two gas flow control elements for a gas dilution system for preparing a diluted gas mixture at a required gas ratio, whereas each of the at least two gas flow control elements respectively feature an integrated measuring orifice and is designed as top piece in the form of a valve, so that it can be connected with a gas container.
